(19) United States
(12) Patent Application Publication
(10) Pub. No.: US 2012/0081675 A1
(43) Pub. Date: Apr. 5, 2012

(54) MASS MEDIA VIDEO PLAYER

(76) Inventor: Hiroshi KANO, Taipei City (TW)

(21) Appl. No.: 12/894,194

(22) Filed: Sep. 30, 2010

(51) Int. Cl. G03B 21/28

(52) U.S. Cl. 353/37

(57) ABSTRACT

The present invention provides a mass media video player which comprises an edge blending apparatus for video signals, plurality of projectors, a plurality of reflector assemblies and a screen. By making use of the optical projection effect, the images projected from the plural projectors are reflected by plural reflector assemblies so as to maximize the size of the image area on screen, and at the same time makes the distance between the screen and the projector as short as possible.

### BACKGROUND OF THE INVENTION

1. Field of the Invention

The present invention relates to a mass media video player, and more particularly to a mass media video player in which an edge blending apparatus for video signals is used to maximize the image area projected from the plural back projectors associated with the aid of the effect of optical projection so as to be able to minimize the distance between the projectors and the screen as short as possible.

2. Description of the prior Art

As it is well known, there are two forms of projection, front projection and back projection. When it is intended to make a large projected picture, the distance between the projector and the screen should be kept larger since the projection distance is proportional to image size. As the projector is located in front of the screen, the projection light comes from the front side of the screen and spectators watch the screen from the front too. In this way, the lecturer who stands directly in front of the screen will be polluted by the light therefrom. Although such a light pollution problem will not occur in the case of back projection, yet a sufficient space is necessary in the rear of the screen. The longer the distance is, the severer the light pollution will be, this is the common problems to both cases. There is a manufacturer who makes use of the short focusing projection to solve the problem of distance, or uses a single back projection TV to effectively make use of the reflection of light.

There are some manufacturers who utilize image blending with a plurality of projectors so as to shorten the projection distance and improve brightness. It is still necessary to have a considerable distance which can not be lessened. As a result, there is no way to maximize the image area, or shorten the distance between the projector and the screen.

### SUMMARY OF THE INVENTION

Accordingly, the gist of the present invention is to provide a mass media video player which comprises a plurality of projectors, an edge blending apparatus for video signals and a plurality of reflector assemblies using the edge blending apparatus for video signals in association with optical reflection effect so as to maximize the image area made by projection from a plurality of back projector, and at the same time minimize the distance between the projector and the screen.

In this mass media video player, the edge blending apparatus at first receives video signals, and then outputs the video signals to a plurality of projectors, and from here outputs the video signals to a plurality of reflector assembly. The reflector assembly can be a primary type or a secondary type. If there is the latter type, an angle is formed between a pair of primary reflector and secondary reflector. After reflected by the primary reflector, the image of the projector is again projected on the secondary reflector and reflected. Final image is projected on the screen to be practically observed. Such a collected image after secondary reflection is a maximized and consolidated image of the plural projectors.

In the present invention, the numbers of screens can be settled transversely 1×N, or longitudinally M×1, in single column or single row to receive an image assembly from the reflectors. In this way, edge blended 1×N transverse and M×1 longitudinal images can be obtained.

In the present invention, the numbers of screens can be settled transversely 1×N, or longitudinally M×1, in single column or single row to receive an image assembly from the reflectors so as to obtain a N×M amplified image assembly in transverse and longitudinal direction. In this way, a single edge blended amplified image consolidated by N×M matrix images.

In the present invention, the image is projected to the screen from behind the screen, therefore the spectators and the lecturer taking seats in front of the screen will never be harmed by optical pollution.

In the present invention, the spectators can enjoy the edge blended and amplified image which has been reflected once or twice, and the distance between the projector and the screen is minimized as short as possible, by no means degrading the brightness of the image cause by excessive projection distance.

### BRIEF DESCRIPTION OF THE DRAWINGS

The above aspects, and other features and advantages of the present invention will become more apparent after a reading of the following detailed description when taken in conjunction with the drawings, in which:

FIG. 1 is a schematic view of the present invention.

FIG. 2 is a three dimensional view in an embodiment of the present invention.

FIG. 3 is a schematic view showing the arrangement of projectors and projected images.

FIG. 4 is a schematic view showing the location of images in another embodiment.

FIG. 5 is a comparison view of the image forming way between the present invention and the prior art.

FIG. 6 is a schematic view in another embodiment of the present invention.

### DETAILED DESCRIPTION OF PREFERRED EMBODIMENTS

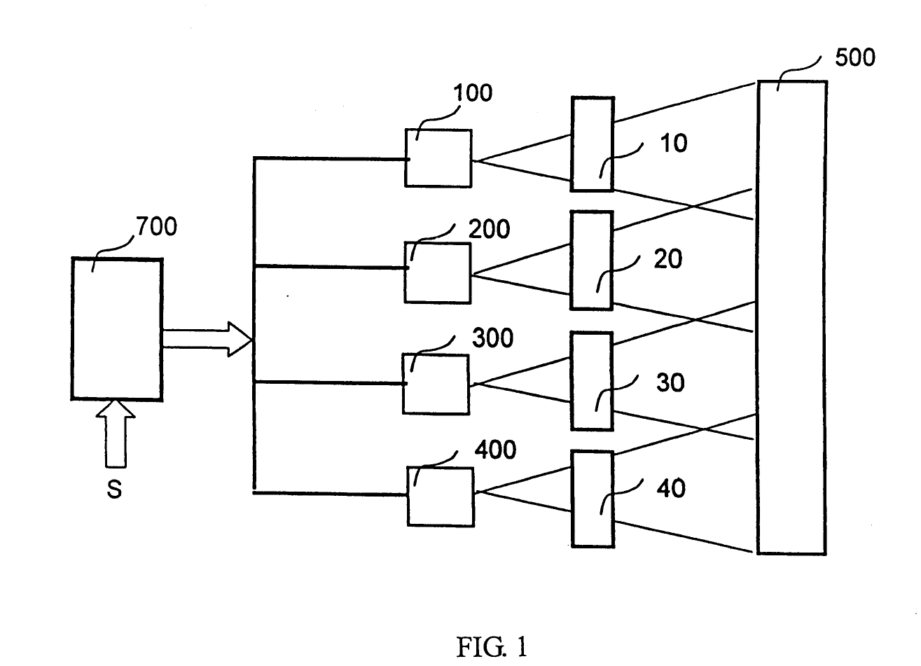

Referring to FIG. 1, the mass media video player of the present invention essentially comprises an edge blending apparatus for video signals (to be abbreviated as edge blending apparatus hereinafter) 700, a plurality of projectors 100, 200, 300, 400, a plurality of reflector assemblies 10, 20, 30, 40, and a screen 500. The edge blending apparatus 700 outputs the video signals S respectively to the projectors 100, 200, 300, 400 after receiving them. The projectors 100, 200, 300, 400 project the blended images respectively to the reflector assemblies 10, 20, 30, 40 to perform light reflection once or twice. After reflection, the images are finally projected on the screen 500 so as to allow the spectators in front of the screen 500 to enjoy watching the pictures displayed thereon.

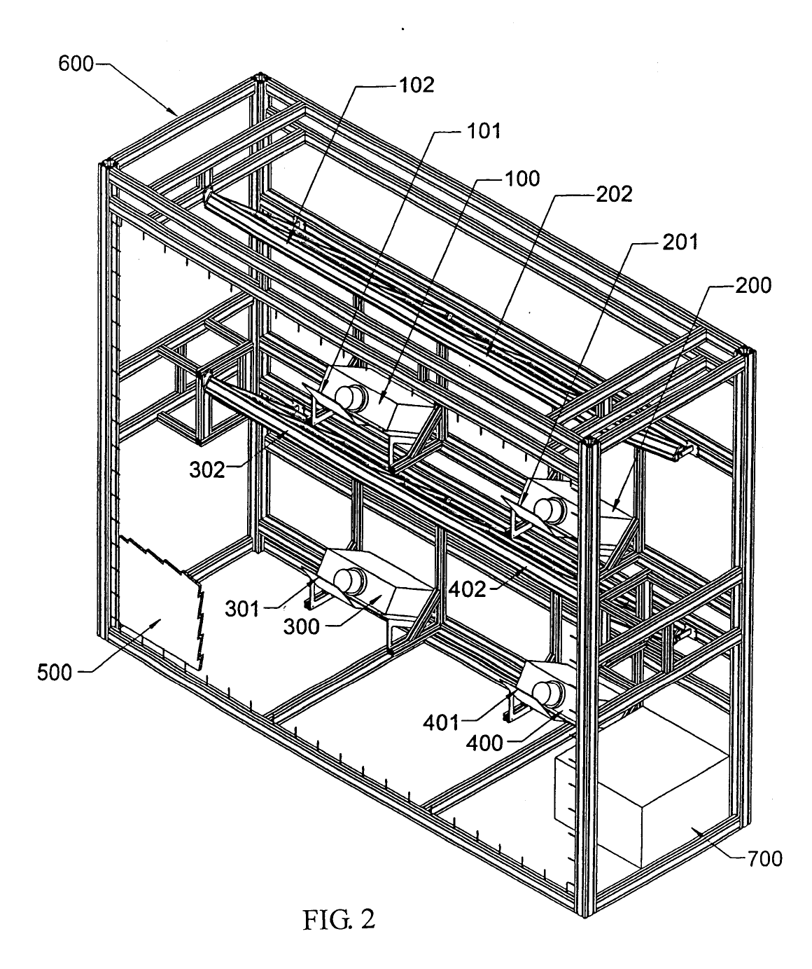

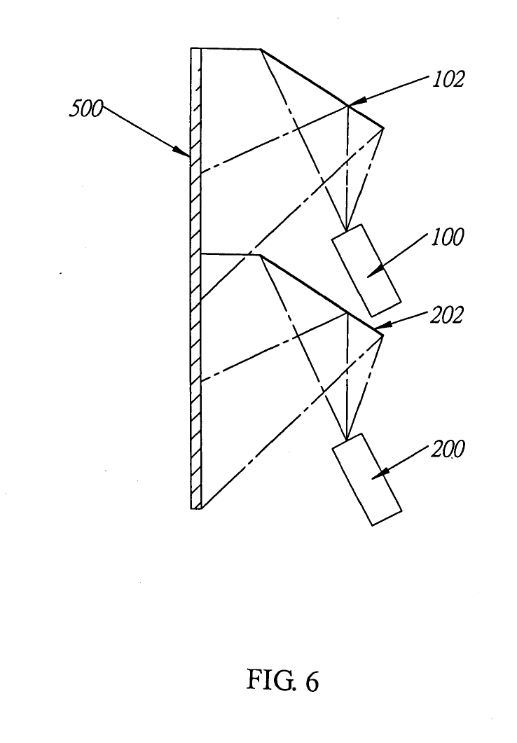

Referring to FIG. 2, the edge blending apparatus 700, the projectors 100, 200, 300, 400, the reflector assemblies 10 (101, 102), 20(201, 202), 30(301, 302), 40(401, 402), and the screen 500 are installed on a frame 600. Wherein each of the reflector assemblies 10, 20, 30, 40 which perform reflection twice has two reflector units 101, 102; 201, 202; 301, 302; and 401, 402. Among them each of the reflector units 101, 201, 301, 401 is located in front of each of the projectors 100, 200, 300, 400 respectively so as to reflect once the images of the aforesaid projectors so that the reflector units 101, 201, 301, 401 are named primary reflector units. On the other hand, the other reflector units 102, 202, 302, 402 are preferably located above the projectors 100, 200, 300, 400 to receive the images reflected from the primary reflector units 101, 201, 301, 401 and perform secondary reflection for them. The images after secondary reflection can reach the screen 500 without being hindered. The reflector units 102, 202, 302, 402 are then called secondary ones. Meanwhile, the primary reflector units 101, 201, 301, 401, the secondary reflector units 102, 202, 302, 402 and even the projectors 100, 200, 300, 400 are made into adjustable so as to be capable of calibrating the errors of images. As shown in FIG. 6, if it is assumed to go without the primary reflector units 101, 201, 301, 401 and only employ the secondary reflector units 102, 202, 302, 402 to perform reflection one time, the effect of shortening the projection distance between the projector and the screen can still be attained.

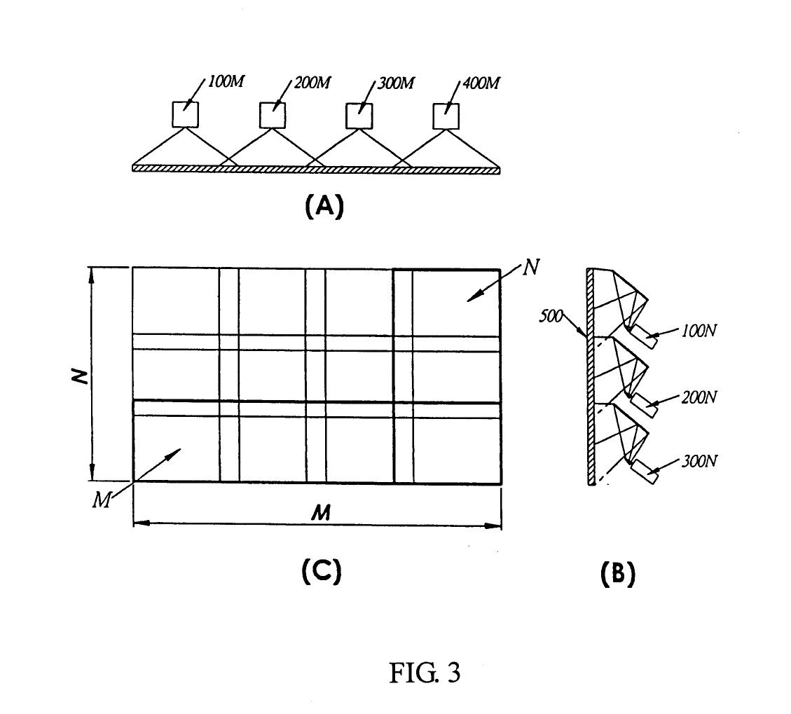

Referring to FIG. 3, in the present invention the arrangement of the projectors and the reflectors may be made in a form that M units of projectors and the reflector units 100M, 200M, 300M, 400M in the horizontal direction only, or the N units of projectors and the reflector units 100N, 200N, 300N in the vertical direction only, or even may be arranged in a form that M units of projectors and the reflector units 100M, 200M, 300M, 400M in the horizontal direction and at the same time N units of projectors and the reflector units 100N, 200N, 300N in the vertical direction. FIG. 3(A) is a view in which M units of projectors and the reflector units are arranged in the horizontal direction only, and their images are displayed a single transversely elongated strip M shown as in FIG. 3(C). If the N units of projectors and the reflector units are arranged only in the vertical direction as shown in FIG. 3(B) the images will be N units single longitudinally elongated strips shown as in FIG. 3(C) If M units of projectors and reflectors are arranged in the horizontal direction and N units of projectors and reflectors in the vertical direction, the images will display a M×N matrix figure shown as in FIG. 3(C).

[Effect of the Invention]

Comparative Case 1

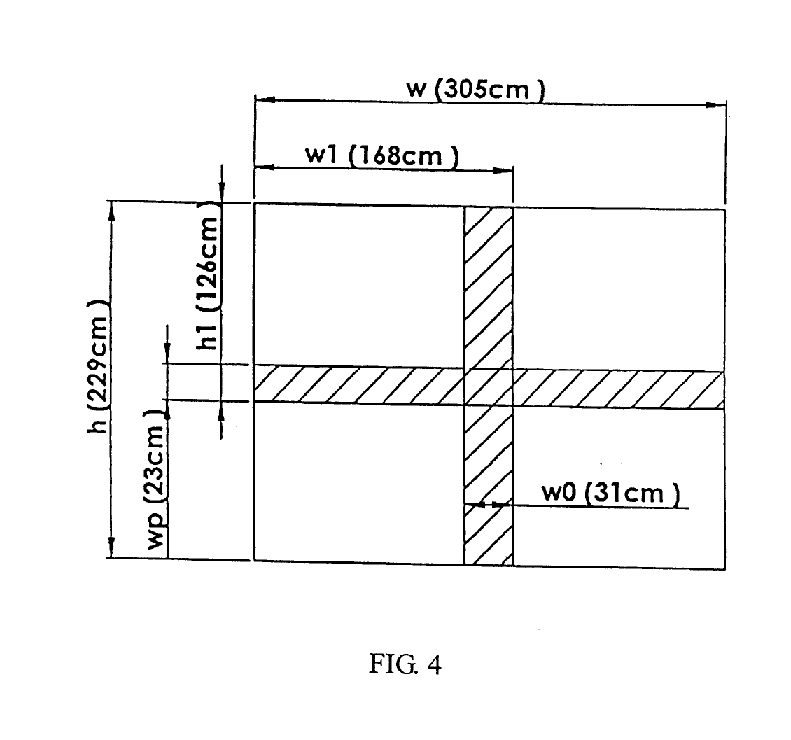

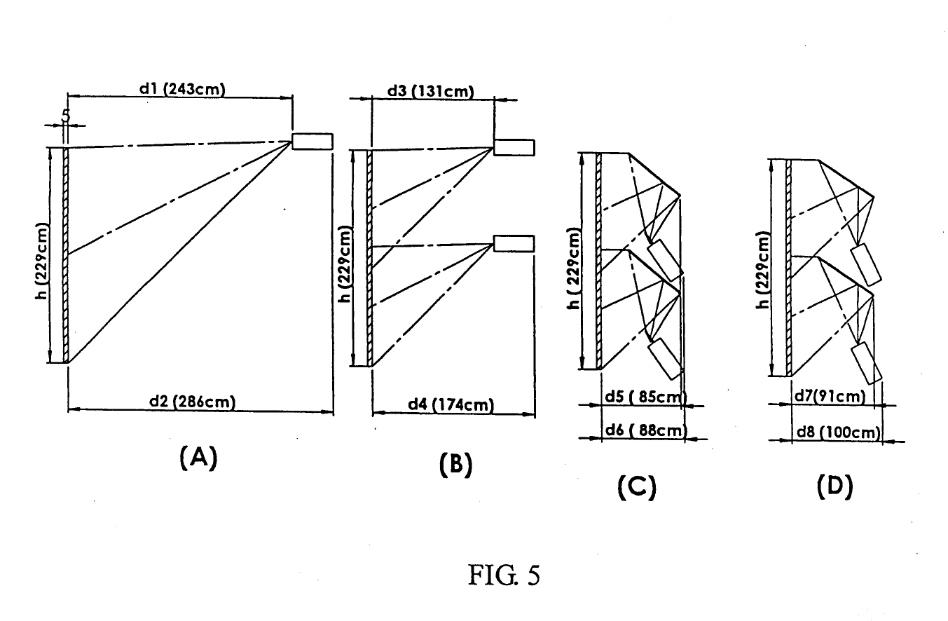

Referring to FIG. 4 and FIG. 5(A), if it is intended to obtain a height(h)=229 cm, width(w)=305 cm image with a single projector of 43 cm length general projector, it is necessary to have 243 cm distance(d1) between the screen and the projector lens, and a distance 286 cm(d2) is needed between the screen and the rear end of the projector. Hence, a 286 cm×229 cm×305 cm space should be left. In this case, since the distance from the projector to the screen is too far, a poor projection effect will result by weakened image brightness.

Comparative Case 2

Referring to FIG. 4 and FIG. 5(B), if it is intended to have an image with a size 229 cm(h)×305 cm(w) as above case, by employing 4 sets of projectors of length 43 cm (general type as above) disposed up and down to perform direct projection, it is observed that a 168 cm(w)×126 cm(h1) image is made by a single projector whereas horizontal blending width(w0) is 31 cm and vertical blending width(wp) is 23 cm for two images. The distance (d3) from the screen to the projector lens requires 131 cm, and the distance(d4) from the screen to the projector rear end requires 174 cm. When compared with the comparative case 1, an improvement is seen in the distance, but there is remained a problem that the space needed for projection is still as large as 174 cm×229 cm×305 cm.

### Embodiment 1

Referring to FIG. 4 and FIG. 5(C), for the same 229 cm(h)×305 cm(w) image, using four projectors of the present invention disposed 2×2 up and down with a primary and a secondary reflector units to project (see FIG. 2), and keeping 88 cm the distance between the screen and the rear end of the projector, we can make the distance from the screen to the end of the secondary reflector unit as short as only 85 cm. By so, the projection distance is greatly shortened and the required space becomes less than ⅓ that of the above comparative case 1, less than ½ that of the comparative case 2.

### Embodiment 2

Referring to FIG. 4 and FIG. 5(D), for the same 229 cm(h)×305 cm(w) image, using four projectors of the present inventing disposed 2×2 up and down, but only with a secondary reflector unit to project, and keeping 100 cm the distance between the screen and the rear end of the projector, we can make the distance from the screen to the rear end of the secondary reflector unit 91 cm. By so, the projection distance can be greatly shortened so that the required space is only 1/2.8 that of the comparative case 1, and 1/1.7 that of the comparative case 2.

The mass media video player of the present invention dexterously makes use of the edge blending apparatus for video signals associated with a primary and a secondary reflector units for plural projectors so as to minimize the distance between the projectors and the screen as short as possible. The invention is a high level technical creation and by no means simply utilizes conventional technology or knowledge, or can be easily made by persons skilled in the arts. The invention has neither been published or put to practical use before, therefore it is entitled for applying patent.

It is apparent to a person skilled in the arts that the basic idea of the invention can be implemented in many different ways. The invention and its embodiments are thus not restricted to the examples described above, but may vary with the scope of the claims.

What is claimed is:

1. A mass media video player comprising an edge blending apparatus for video signals; a plurality of projectors; a plurality of reflector assemblies formed of primary and secondary reflector units, and a screen;
Wherein said primary reflectors are set in front of said projectors lens and said secondary reflectors are set above said projectors, the image projected from said projector is at first reflected by said primary reflectors, and again reflected and amplified by said secondary reflectors, finally said image is projected on said screen to be practically observed by spectators, said amplified image is formed into an edge blended image by said edge blending apparatus for video signals so as to maximize the area of said image, but minimize the distance between said projector and said screen as short as possible.

2. The video player as in claim 1, wherein said reflector assembly is only composed of secondary reflectors.

3. The video player as in claim 1, wherein said projectors and said reflector assemblies are disposed in transverse single row array for multiple units.

4. The video player as in claim 2, wherein said projectors and said reflector assemblies are disposed in transverse single row array for multiple units.

5. The video player as in claim 1, wherein said projectors and said reflector assemblies are disposed in longitudinal single column array for multiple units.

6. The video player as in claim 2, wherein said projectors and said reflector assemblies are disposed in longitudinal single column array for multiple units.

7. The video player as in claim 1, wherein said projectors and said reflector assemblies are disposed in transverse multi-column arrays for multiple units and longitudinal multi-row arrays for multiple units.

8. The video player as in claim 2, wherein said projectors and said reflector assemblies are disposed in transverse multi-column arrays for multiple units and longitudinal multi-row arrays for multiple units.

9. The video player as in claim 7, wherein said projectors and said reflector assemblies disposed in transverse multi-column arrays for multiple units and longitudinal multi-row arrays for multiple units are configurated in a matrix form.

10. The video player as in claim 8, wherein said projectors and said reflector assemblies disposed in transverse multi-column arrays for multiple units and longitudinal multi-row arrays for multiple units are configurated in a matrix form.

11. The video player as in claim 1, wherein said edge blending apparatus for video signals, said projectors, said reflector assemblies and said screen are installed on a machine frame.

12. The video player as in claim 2, wherein said edge blending apparatus for video signals, said projectors, said reflector assemblies and said screen are installed on a machine frame.

13. The video player as in claim 9, wherein said reflector units contained in said reflector assembly and said projector are adjustable or non-adjustable.
